(19) United States
(12) Patent Application Publication
(10) Pub. No.: US 2026/0254470 A1
(43) Pub. Date: Aug. 27, 2026

(54) INTERFERENCE CANCELLATION SIGNAL GENERATION METHOD AND APPARATUS, SIGNAL PROCESSING DEVICE, AND STORAGE MEDIUM

(71) Applicant: ZTE CORPORATION, Shenzhen, Guangdong (CN)

(72) Inventor: Chunxu WANG, Shenzhen, Guangdong (CN)

(21) Appl. No.: 18/871,238

(22) PCT Filed: Jun. 26, 2023
(86) PCT No.: PCT/CN2023/102349

§ 371 Date: Dec. 3, 2024

(30) Foreign Application Priority Data
Jun. 30, 2022 (CN) 202210764014.5

(51) Int. Cl. H04B 1/12; H04B 1/16

(52) U.S. Cl. CPC H04B 1/12; H04B 1/16

(57) ABSTRACT

The present disclosure provides a method for generating an interference cancellation signal, including: performing IQ spectrum shifting with a preset bandwidth on a received baseband IQ signal to obtain an initial interference cancellation signal; and performing power control processing on the initial interference cancellation signal to obtain a final interference cancellation signal. The present disclosure further provides an apparatus for generating an interference cancellation signal, a signal processing device including the apparatus for generating the interference cancellation signal, and a computer-readable storage medium.

### CROSS-REFERENCE TO RELATED APPLICATIONS

The present disclosure claims the priority of Chinese Patent Application No. 202210764014.5, filed on Jun. 30, 2022, the contents of which are incorporated herein in their entirety by reference.

### TECHNICAL FIELD

The present disclosure relates to the field of microwave communications, and in particular, to a method for generating an interference cancellation signal, an apparatus for generating an interference cancellation signal, a signal processing device, and a computer-readable storage medium.

### BACKGROUND

In a microwave communication system, Co-channel Dual polarization (CCDP) refers to that signals are transmitted in two paths respectively by using a horizontal polarization wave and a vertical polarization wave in one channel, and the CCDP is a capacity expansion technology for space diversity in a microwave system. The CCDP uses two orthogonal polarization waves to transmit signals to realize doubling of transmission capacity, and adopts a Cross-Polarization Interference Cancellation (XPIC) technology to eliminate cross interference between the two orthogonal polarization waves.

In E-Band microwave systems, due to expectations on a relatively large bandwidth, an IQ (i.e., in-phase and quadrature-phase) zero intermediate frequency architecture is usually adopted, and an XPIC signal is transmitted in a form of a baseband IQ signal. The baseband IQ signal has a relatively high expectation for a transmission channel, two pairs of differential signals are to be received and transmitted respectively, and transmissions of an I differential signal and a Q differential signal are expected to have similar group delays, similar insertion losses, similar return losses and the like. Therefore, the channel is desired to have a relatively good S parameter (i.e., scattering parameter) and a relatively good group delay. Some related schemes in the market adopt an optical interface for transmission. In these schemes, the baseband IQ signal to be transmitted is firstly subjected to differential encoding forming processing, and then is modulated through a laser to an optical cable for transmission, so that the schemes are relatively complex, and furthermore, a special optical module is desired for receiving and transmitting polarization interference cancellation signals, resulting in a relatively high cost, and a poor engineering usability.

### SUMMARY

As a first aspect of the present disclosure, there is provided a method for generating an interference cancellation signal, including: performing IQ spectrum shifting with a preset bandwidth on a received baseband IQ signal to obtain an initial interference cancellation signal; and performing power control processing on the initial interference cancellation signal to obtain a final interference cancellation signal.

As a second aspect of the present disclosure, there is provided an apparatus for generating an interference cancellation signal, including: a spectrum shifting module configured to perform IQ spectrum shifting with a preset bandwidth on a received baseband IQ signal to obtain an initial interference cancellation signal, the preset bandwidth being less than a bandwidth of the baseband IQ signal; a power control processing module configured to perform power control processing on the initial interference cancellation signal to obtain a final interference cancellation signal.

As a third aspect of the present disclosure, there is provided a signal processing device, including: the apparatus for generating the interference cancellation signal in the second aspect of the present disclosure; a second channel matching component configured to receive a final interference cancellation signal sent by a partner device; a main signal processing apparatus configured to receive a baseband IQ signal and the final interference cancellation signal transmitted by the partner device, and process the received baseband IQ signal by using the received interference cancellation signal to obtain a main signal to be transmitted; and a main signal transmission apparatus configured to transmit the main signal to be transmitted to an opposite-end device.

As a fourth aspect of the present disclosure, there is provided a computer-readable storage medium having a computer program stored thereon, the computer program, executed by a processor, causes the processor to implement the method for generating the interference cancellation signal in the first aspect of the present disclosure.

### BRIEF DESCRIPTION OF DRAWINGS

FIG. 1 is a flowchart of an implementation of a method for generating an interference cancellation signal according to the present disclosure.

FIG. 2 is a flowchart of an implementation of operation S120 of a method for generating an interference cancellation signal according to the present disclosure.

FIG. 3 is a flowchart of an implementation of a method for generating an interference cancellation signal according to the present disclosure.

FIG. 4 is a block diagram of an implementation of an apparatus for generating an interference cancellation signal according to the present disclosure.

FIG. 5 is a schematic diagram of a signal flow of an apparatus for generating an interference cancellation signal according to the present disclosure.

FIG. 6 is a schematic diagram of an implementation of a signal processing device according to the present disclosure.

FIG. 7 is a schematic diagram of a signal flow of an IQ interference signal entering a baseband processing component according to the present disclosure.

FIG. 8 is a schematic diagram of configuration of an IQ protection component according to the present disclosure.

FIG. 9 is a schematic diagram of a first channel matching component and a second channel matching component being connected according to the present disclosure.

### DETAIL DESCRIPTION OF EMBODIMENTS

In order to make those skilled in the art better understand the technical solutions of the present disclosure, a method for generating an interference cancellation signal, an apparatus for generating an interference cancellation signal, a signal processing device, and a computer-readable storage medium, provided in the present disclosure, are described in detail below with reference to the accompanying drawings.

Exemplary embodiments are described in detail below with reference to the accompanying drawings, but the exemplary embodiments may be embodied in different forms, and the present disclosure should not be construed as limited to the embodiments set forth herein. The embodiments are illustrated to make the present disclosure more thorough and complete, and for those skilled in the art more fully understanding the scope of the present disclosure.

The embodiments of the present disclosure and technical features in the embodiments may be combined with each other if no conflict is incurred.

As used in the present disclosure, a term “and/or” includes any and all combinations of at least one of listed items.

The terms used in the present disclosure are for a purpose of describing particular embodiments only, and are not intended to limit the present disclosure. As used in the present disclosure, singular forms “a” and “the” include plural forms as well, unless the context clearly defines otherwise. It should further be understood that terms “includes/comprises” and/or “made of/consisted of” in the present disclosure are used to specify a presence of at least one of recited features, integers, steps, operations, elements or components, but do not preclude a presence or an addition of at least one of other features, integers, steps, operations, elements, components or groups thereof.

Unless otherwise defined, meanings of all terms (including technical terms and scientific terms) used herein are the same as meanings commonly understood by one of ordinary skills in the art. It should further be understood that terms, such as those defined in common dictionaries, should be construed as having a meaning that is consistent with that in background of the existing art and the present disclosure, and should not be construed as having an idealized or over-formal meaning, unless expressly defined in the present disclosure.

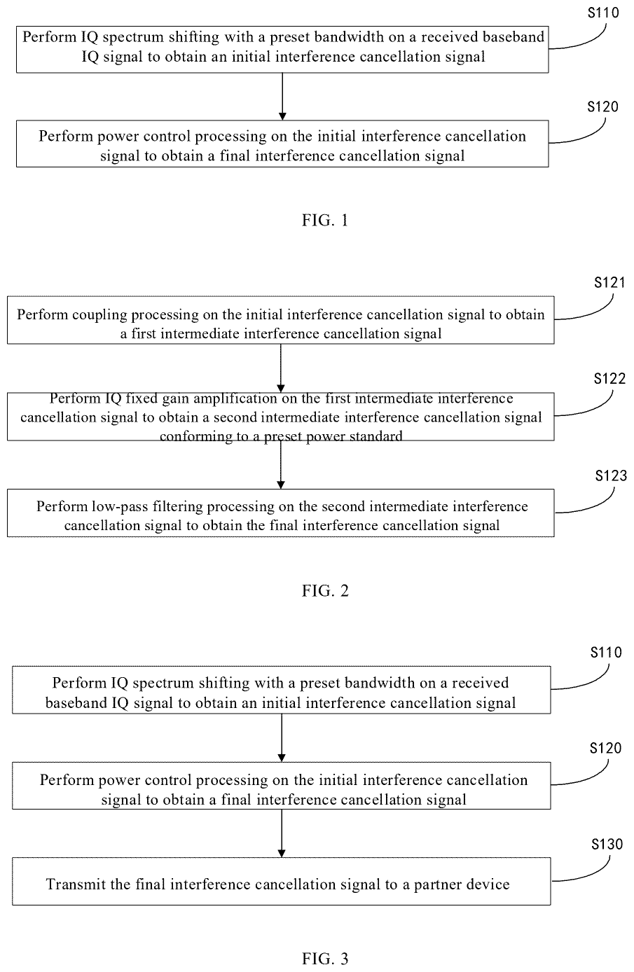

Mutual transmission of baseband IQ signals has relatively high expectations on a channel, and in order to achieve direct transmission of IQ signals in multi-signal cables, noise interference near low frequencies within the channel is to be taken into account. As a first aspect of the present disclosure, as shown in FIG. 1, there is provided a method for generating an interference cancellation signal, which at least includes, but not limited to, operations S110 and S120.

At operation S110, performing IQ spectrum shifting with a preset bandwidth on a received baseband IQ signal to obtain an initial interference cancellation signal.

At operation S120, performing power control processing on the initial interference cancellation signal to obtain a final interference cancellation signal.

In the method for generating the interference cancellation signal, the spectrum shifting is performed on the baseband IQ signal, so that the initial interference cancellation signal has gotten rid of DC low-frequency noise interference. Then, the power control processing is performed on the initial interference cancellation signal to obtain the final interference cancellation signal. The final interference cancellation signal is sent to a partner device, so that XPIC can be realized, and IQ signals can be transmitted in the multi-signal cables. Therefore, the method for generating the interference cancellation signal in the present disclosure is relatively simple to be realized.

The final interference cancellation signal generated through above operations S110 and S120 is suitable to be mutually transmitted in the multi-signal cable (for example, a category 6a twisted-pair cable), so that no optical transceiver module is desired, an interconnection structure of an XPIC system is simplified, and an overall cost of the XPIC system is reduced.

In the present disclosure, the “preset bandwidth” for the spectrum shifting performed on the IQ signal is not particularly limited, but at least ensures that the initial interference cancellation signal can get rid of the DC low-frequency noise interference. In some implementations, the preset bandwidth is one-half of a bandwidth of the baseband IQ signal. A baseband processing component of a communication device can enable shifting of one-half bandwidth of the baseband IQ signal, therefore, in the present disclosure, the preset bandwidth may be one-half of the bandwidth of the baseband IQ signal, so that a function of the existing baseband processing component can be fully utilized, and no new device for spectrum shifting is to be introduced.

In the present disclosure, how to perform power control processing on the initial interference cancellation signal is not particularly limited. In some implementations, as shown in FIG. 2, performing power control processing on the initial interference cancellation signal at least includes, but is not limited to, operations S121 to S123.

At operation S121, performing coupling processing on the initial interference cancellation signal to obtain a first intermediate interference cancellation signal.

At operation S122, performing IQ fixed gain amplification on the first intermediate interference cancellation signal to obtain a second intermediate interference cancellation signal conforming to a preset power standard.

At operation S123, performing low-pass filtering processing on the second intermediate interference cancellation signal to obtain the final interference cancellation signal.

Through operations S121 and S122, the first intermediate interference cancellation signal generated by a coupling component is to be output from a port of a channel matching component at the preset power standard. Through operation S123, an out-of-band interference in a frequency domain of the IQ signal can be eliminated to obtain a purer frequency spectrum, and the performance of the final interference cancellation signal for interference cancellation can be better improved.

In response to that the baseband IQ signal is an H-polarization (i.e., horizontal polarization) baseband IQ signal, the final interference cancellation signal is an H-polarization interference cancellation signal; and in response to that the baseband IQ signal is a V-polarization (i.e., vertical polarization) baseband IQ signal, the final interference cancellation signal is a V-polarization interference cancellation signal.

In the present disclosure, how to obtain the baseband IQ signal is not particularly limited. For example, a frequency spectrum from an air interface at an opposite terminal may be received by a Radio Frequency (RF) receiver of the microwave system and then down-converted to obtain the baseband IQ signal.

In the present disclosure, the final interference cancellation signal is to be sent to the partner device to enable the partner device to realize the XPIC technology. Accordingly, as shown in FIG. 3, the method for generating the interference cancellation signal may further include operation S130.

At operation S130, transmitting the final interference cancellation signal to a partner device.

It should be noted that, if the final interference cancellation signal is an H-polarization signal, the partner device may perform interference cancellation processing on a V-polarization main signal processed by the partner device by using the H-polarization signal; if the final interference cancellation signal is a V-polarization signal, the partner device may perform interference cancellation processing on an H-polarization main signal processed by the partner device by using the V-polarization signal.

In the present disclosure, the “partner device” is not particularly limited, and any device may be referred to as a “partner device” as long as the device can process the received baseband IQ signal by using the final interference cancellation signal generated by an electronic device executing the method for generating the interference cancellation signal in the present disclosure to obtain a main signal to be transmitted. For example, the “partner device” may be a communication device in the same geographical area as the electronic device executing the method for generating the interference cancellation signal.

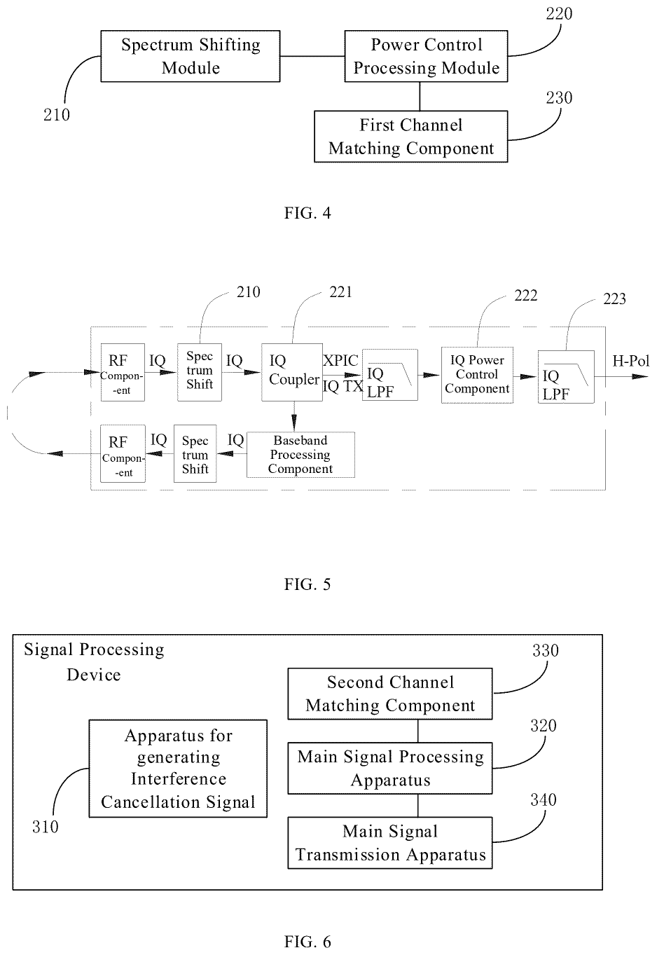

As a second aspect of the present disclosure, there is provided an apparatus for generating an interference cancellation signal, and as shown in FIG. 4, the apparatus for generating the interference cancellation signal includes a spectrum shifting module 210 and a power control processing module 220. The apparatus for generating the interference cancellation signal is configured to execute the method for generating the interference cancellation signal in the first aspect of the present disclosure.

The spectrum shifting module 210 is configured to execute operation S110, i.e., the spectrum shifting module 210 is configured to perform IQ spectrum shifting with a preset bandwidth on a received baseband IQ signal to obtain an initial interference cancellation signal, and the preset bandwidth is less than a bandwidth of the baseband IQ signal.

The power control processing module 220 is configured to execute operation S120, i.e., the power control processing module 220 is configured to perform power control processing on the initial interference cancellation signal to obtain a final interference cancellation signal.

With the apparatus for generating the interference cancellation signal, the spectrum shifting is performed on the baseband IQ signal for generating the interference cancellation signal, so that the initial interference cancellation signal has gotten rid of DC low-frequency noise interference. Then, the power control processing is performed on the initial interference cancellation signal to obtain the final interference cancellation signal. The final interference cancellation signal is sent to a partner device, so that XPIC can be realized, and IQ signals can be transmitted in the multi-signal cables. Therefore, the apparatus for generating the interference cancellation signal in the present disclosure is relatively simple to be realized.

In some implementations, the preset bandwidth is one-half of the bandwidth of the baseband IQ signal.

In the present disclosure, a specific structure of the power control processing module 220 is not particularly limited, and in some implementations, as shown in FIG. 5, the power control processing module 220 includes an IQ coupling component 221, an IQ power control component 222 and a low-pass filtering component 223.

The IQ coupling component 221 is configured to perform coupling processing on the initial interference cancellation signal to obtain a first intermediate interference cancellation signal.

The IQ power control component 222 is configured to perform IQ fixed gain amplification on the first intermediate interference cancellation signal to obtain a second intermediate interference cancellation signal conforming to a preset power standard.

The low-pass filtering component 223 is configured to perform low-pass filtering processing on the second intermediate interference cancellation signal to obtain the final interference cancellation signal.

As described above, the baseband IQ signal is an H-polarization baseband IQ signal or a V-polarization baseband IQ signal.

In some implementations, the apparatus for generating the interference cancellation signal further includes a first channel matching component 230 configured to transmit the final interference cancellation signal to the partner device.

In some implementations, the first channel matching component 230 may include an RJ45 connector. Through the RJ45 connector, interconnection between the H-polarization interference signal cable and the V-polarization interference signal cable can be realized.

As a third aspect of the present disclosure, there is provided a signal processing device, and as shown in FIG. 6, the signal processing device includes an apparatus 310 for generating an interference cancellation signal, a main signal processing apparatus 320, a second channel matching component 330, and a main signal transmission apparatus 340.

The apparatus 310 for generating the interference cancellation signal is the apparatus for generating the interference cancellation signal in the second aspect of the present disclosure. The main signal processing apparatus 320 is configured to receive a baseband IQ signal and a final interference cancellation signal transmitted by a partner device, and process the received baseband IQ signal by using the received interference cancellation signal to obtain a main signal to be transmitted.

The second channel matching component 330 is configured to receive the final interference cancellation signal sent by the partner device.

The main signal transmission apparatus 340 is configured to send the main signal to be transmitted to an opposite-end device.

As described above, with the apparatus 310 for generating the interference cancellation signal, the spectrum shifting is performed on the baseband IQ signal for generating the interference cancellation signal, so that the initial interference cancellation signal has gotten rid of DC low-frequency noise interference. Then, the power control processing is performed on the initial interference cancellation signal to obtain the final interference cancellation signal. The final interference cancellation signal is sent to a partner device, so that XPIC can be realized, and IQ signals can be transmitted in the multi-signal cables. Therefore, the apparatus for generating the interference cancellation signal in the present disclosure is relatively simple to be realized, accordingly, a cost of the signal processing device is relatively low.

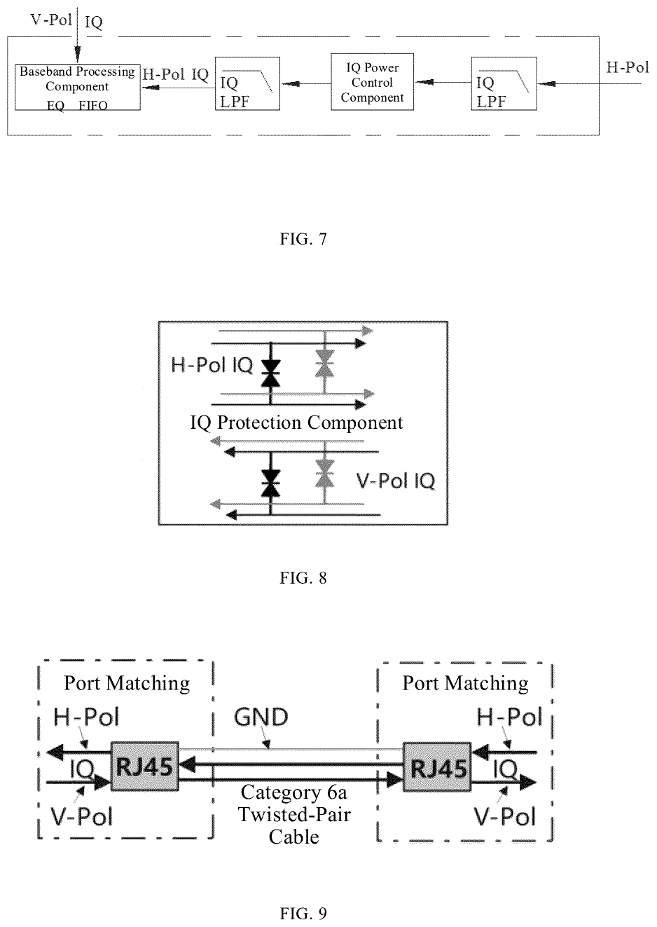

As shown in FIG. 7, an IQ interference signal entering a baseband processing component goes through a multilevel first-input-first-output (FIFO) memory for coherent matching, equalization alignment, or the like. The better the spectrum quality of the received interference IQ signal is, and the smaller the usage depth of the FIFO memory is, the easier the interference cancellation demodulation is to be completed.

The mutual transmission of polarization interference cancellation signals belongs to outdoor line transmission, therefore, as shown in FIG. 8, the polarization interference cancellation signals are to be protected in reliability at a port (i.e., the first channel matching component and the second channel matching component) of a transceiver component. For example, electro-static discharge (ESD) protection, lightning strike protection, surge protection, or the like may be performed at the port of the transceiver component. Typically, a length of a polarization signal transmission cable does not exceed 1 meter, therefore, static electricity is a common damage, and in some implementations, an ESD apparatus may be provided at the port (i.e., the first channel matching component and the second channel matching component) of the transceiver.

In some implementations, the second channel matching component 330 includes an RJ45 connector.

In some implementations, the second channel matching component 330 is connected to a first channel matching component of the partner device through a polarization signal transmission cable, and a length of the polarization signal transmission cable does not exceed 1 meter.

In the present disclosure, as shown in FIG. 9, the polarization signal transmission cable may be a category 6a twisted-pair cable.

In the present disclosure, through a custom interface, and in a physical form of the RJ45 connector, interconnection between an H-Polarization interference signal cable and a V-Polarization interference signal cable is realized. The custom interface mainly includes two groups of baseband IQ differential signal definitions and a group of shielding ground signals as follows:
a. H-Polarization IQ differential signal, BBI±(Pin5/6), BBQ±(Pin7/8);
b. V-Polarization IQ differential signal, BBI±(Pin1/2), BBQ±(Pin3/4);
c. Ground signal for a shielding layer of a transmission channel.

The baseband IQ signals are mutually transmitted in multi-signal cables, in addition to processing such as spectrum shifting and filtering at a transceiver component of the baseband IQ signal (i.e., the apparatus for generating the interference cancellation signal and a main signal processing apparatus of the opposite-end device), there are also relatively high expectations on the transmission channel. The transmission channel is to support 4 pairs of differential signals to be transmitted simultaneously, and has relatively high isolation between IQ differential pairs and relatively good shielding capability. The category 6a twisted-pair cable supports the transmission in the multi-signal cables, and by customizing a line order, isolation between IQ polarization cancellation signals is ensured. According to demodulation capability of a baseband (i.e., Modem) and a use scene of a product, a transmission distance of a cable is customized within 1 meter, a group delay of channel transmission is effectively controlled, and demodulation capability of the baseband processing component is met.

In the present disclosure, for transmitting signals, the RJ45 connector or the category 6a twisted-pair cable is not limiting, the multi-signal cables supporting 8-core IQ differential signal transmission can also meet the transmission expectations.

The signal processing device provided in the present disclosure may be a microwave E-Band all-outdoor integrated transmission system, and may also be an IQ zero intermediate frequency architecture system such as microwave high-frequency bands D-Band and W-Band.

By the apparatus for generating the interference cancellation signal in the signal processing device executing the method for generating the interference cancellation signal, difficulty of generating the interference cancellation signal is reduced, and the IQ baseband signal can be transmitted in the twisted-pair cable, resulting in a reduced overall communication cost.

As a fourth aspect of the present disclosure, there is provided a computer-readable storage medium having a computer program stored thereon, the computer program, executed by a processor, causes the processor to implement the method for generating the interference cancellation signal according to the first aspect of the present disclosure.

It should be understood by those of ordinary skill in the art that all or some of the operations in the method, the functional modules/components in the system, the apparatus described above may be implemented as software, firmware, hardware, or suitable combinations thereof. In a hardware implementation, the division between the functional modules/components stated above does not correspond to the division of physical components; for example, one physical component may have a plurality of functions, or one function or operation may be performed through a cooperation of several physical components. Some or all of the physical components may be implemented as software executed by a processor, such as a central processing unit, a digital signal processor or a microprocessor, or may be implemented as hardware, or may be implemented as an integrated circuit, such as an application specific integrated circuit. Such software may be distributed on a computer-readable medium, the computer-readable medium may include computer storage medium (or non-transitory medium) and communication medium (or transitory medium). As known to those skilled in the art, the term of the computer storage medium includes volatile/nonvolatile or removable/non-removable medium used in any method or technology for storing information (such as computer-readable instructions, data structures, program modules and other data). The computer storage medium includes, but is not limited to, RAM, ROM, EEPROM, a flash memory or other memory techniques, CD-ROM, a Digital Video Disk (DVD) or other optical discs, magnetic cassettes, magnetic tapes, magnetic disks or other magnetic storage devices, or any other medium which can be used to store the desired information and can be accessed by a computer. In addition, as known to those skilled in the art, the communication medium generally includes computer-readable instructions, data structures, program modules or other data in a modulated data signal, such as a carrier wave or other transmission mechanism, and may include any information delivery medium.

The present disclosure describes the exemplary embodiments, and although specific terms are employed, they are used and should only be interpreted in a generic and descriptive meaning but not for purposes of a limitation. In some examples, it is apparent to those skilled in the art that features, characteristics and/or elements described in connection with specific embodiments may be used alone or in combination with features, characteristics and/or elements described in connection with other embodiments, unless explicitly stated otherwise. Therefore, it should be understood by those skilled in the art that various changes in form and details may be made without departing from the scope of the present disclosure as set forth in the appended claims.

1. A method for generating an interference cancellation signal, comprising:
performing IQ spectrum shifting with a preset bandwidth on a received baseband IQ signal to obtain an initial interference cancellation signal; and
performing power control processing on the initial interference cancellation signal to obtain a final interference cancellation signal.

2. The method according to claim 1, wherein the preset bandwidth is one-half of a bandwidth of the baseband IQ signal.

3. The method according to claim 1, wherein the performing power control processing on the initial interference cancellation signal comprises:
performing coupling processing on the initial interference cancellation signal to obtain a first intermediate interference cancellation signal;
performing IQ fixed gain amplification on the first intermediate interference cancellation signal to obtain a second intermediate interference cancellation signal conforming to a preset power standard; and
performing low-pass filtering processing on the second intermediate interference cancellation signal to obtain the final interference cancellation signal.

4. The method according to claim 1, wherein the baseband IQ signal is an H-polarization baseband IQ signal or a V-Polarization baseband IQ signal.

5. The method according to claim 1, further comprising:
transmitting the final interference cancellation signal to a partner device.

6. An apparatus for generating an interference cancellation signal, comprising:
a spectrum shifting module configured to perform IQ spectrum shifting with a preset bandwidth on a received baseband IQ signal to obtain an initial interference cancellation signal, with the preset bandwidth being less than a bandwidth of the baseband IQ signal;
a power control processing module configured to perform power control processing on the initial interference cancellation signal to obtain a final interference cancellation signal.

7. The apparatus according to claim 6, wherein the preset bandwidth is one-half of the bandwidth of the baseband IQ signal.

8. The apparatus according to claim 6, wherein the power control processing module comprises:
an IQ coupling component configured to perform coupling processing on the initial interference cancellation signal to obtain a first intermediate interference cancellation signal;
an IQ power control component configured to perform IQ fixed gain amplification on the first intermediate interference cancellation signal to obtain a second intermediate interference cancellation signal conforming to a preset power standard; and
a low-pass filtering component configured to perform low-pass filtering processing on the second intermediate interference cancellation signal to obtain the final interference cancellation signal.

9. The apparatus according to claim 6, wherein the baseband IQ signal is an H-polarization baseband IQ signal or a V-Polarization baseband IQ signal.

10. The apparatus according to claim 6, further comprising a first channel matching component configured to transmit the final interference cancellation signal to a partner device.

11. The apparatus according to claim 10, wherein the first channel matching component comprises an RJ45 connector.

12. A signal processing device, comprising:
the apparatus for generating the interference cancellation signal according to claim 6;
a second channel matching component configured to receive a final interference cancellation signal sent by a partner device;
a main signal processing apparatus configured to receive a baseband IQ signal and the final interference cancellation signal transmitted by the partner device, and process the received baseband IQ signal by using the received interference cancellation signal to obtain a main signal to be transmitted; and
a main signal transmission apparatus configured to transmit the main signal to be transmitted to an opposite-end device.

13. The device according to claim 12, further comprising an electro-static discharge (ESD) apparatus configured to perform ESD protection on the second channel matching component.

14. The device according to claim 12, wherein the second channel matching component comprises an RJ45 connector.

15. The device according to claim 12, wherein the second channel matching component is connected to a first channel matching component of the partner device by a polarization signal transmission cable.

16. The device according to claim 15, wherein the polarization signal transmission cable is a category 6a twisted-pair cable, and a length of the polarization signal transmission cable is at most 1 meter.

17. A non-transitory computer-readable storage medium having a computer program stored thereon, the computer program, executed by a processor, causes the processor to implement the interference cancellation signal generation method according to claim 1.
